(19) United States
(12) Patent Application Publication
(10) Pub. No.: US 2010/0124363 A1
(43) Pub. Date: May 20, 2010

(54) DISPLAY PRIVACY SYSTEM

(75) Inventors: Martin EK, Dalby (SE); Bo LARSSON, Malmo (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/274,785

(22) Filed: Nov. 20, 2008

(51) Int. Cl. G06K 9/00

(52) U.S. Cl. 382/118

(57) ABSTRACT

A system for controlling a display privacy filter on a display of an electronic device may include an image capturing unit to capture an image of an object situated in front of the display, detecting the number of human faces on the captured image, and activating the privacy filter on the display if more than one face is detected on the captured image.

### TECHNICAL FIELD

The present invention generally relates to the field of electronic devices and, more particularly to a method and arrangement for controlling a display privacy filter for the electronic device.

### BACKGROUND

Electronic devices having a display, such as personal computers (“PCs”), are becoming increasingly commonplace. Such electronic devices may be portable, for example, laptop computers, cordless and cellular telephones, personal digital assistants (PDAs), etc. Users of such portable electronic devices typically take these devices with them anywhere they go, which increases the risk of unintended divulgence of personal and/or confidential information to individuals other than the user who may view the display, e.g., passers-by who may glance at the display.

Display privacy filters are designed to aid users in protecting sensitive information by shielding the display screen view from anyone viewing the display from an angle, e.g., the side of the monitor, while allowing persons positioned directly in front of the display to view content being displayed.

Since many applications run on communication device are personal in nature, privacy filters are also becoming increasingly popular for mobile phones, for example, in Japan. A conventional solution involves attaching a miniature version of the filters used on laptops onto the phone display. However, conventional privacy filter solutions suffer from some major drawbacks, for example, the filters can adversely affect the color reproduction and also “steal” some light. This results in a corresponding requirement for increased backlighting in the display, which means higher power consumption and thus an adverse impact on battery performance.

A potential resolution of these issues may be to develop electronically controlled built-in privacy filters, which can be activated and deactivated by a user, for example, using a menu system of the device. It could then be possible for users to switch the filter on only on an as-needed basis, and thereby conserve color and battery performance. However, some users may be inclined to just leave the filter on, since manual user interaction would be necessary to activate/deactivate the filter, especially if the phone does not have a dedicated button for this purpose. In addition, some users may take a “better safe than sorry” approach to filter use, reasoning that it is preferable not to turn the filter off than to risk forgetting to turn it on later when discreet use of the device is desired. For example, the user may later be so engrossed on displayed confidential information on the monitor so as to be unaware that another person has approached the user, for example, from behind, who may surreptitiously peer at the sensitive information. Or, the user may be find himself in environment (e.g., seated on mass transit) in which the user is flanked by individuals who will necessarily be privy to what is displayed. In other circumstances, a user may using a gaming console and seated next to a competitor, for example, in a car, and unbeknownst to the user, the competitor may be able to view the user's gaming console, to the competitive disadvantage of the user.

Further, user-activated electronically-controlled privacy filter functionality adds complexity to the use of the device, presenting difficulties for the user in operating the device without consulting a manual. A possible solution may be to introduce a dedicated hardware button which could be used for manipulating the electronically controlled privacy filter. Such a solution may be somewhat easy to use for a user; however, additional production costs are involved. Furthermore, an extra dedicated button on a portable electronic device adds increased volume to the limited design space available in such devices. As a consequence, some or all other hardware buttons and/or the display have to be reduced in scale to accommodate a new dedicated input mechanism.

Thus, maintaining privacy by not compromising sensitive information when using an electronic device that includes a display presents a design challenge in manufacturing such devices.

In addition, as commercial competition increases among portable communication devices, marketing opportunities exist for increased functionality and enhanced user features.

### SUMMARY

Embodiments of the present invention may resolve at least some of the above-mentioned issues and provide a superior user privacy feature with respect to displayed information.

A first embodiment of the present invention is directed to a method performed in an electronic device which controls a display privacy filter. The display privacy filter may be provided for a display of the electronic device. The electronic device may include an image capturing unit. The image capturing unit may be configured to capture an image of an object situated in view of the display. The method may include the step of capturing an image of the object. The method may include the step of detecting more than one human face present in the captured image. The method may include the step of activating the privacy filter on the display when more than one face is detected on the captured image.

A second embodiment of the present invention may include the features of the first embodiment, and the further step of deactivating the privacy filter on the display if only one face is detected on the captured image.

A third embodiment of the present invention may include the features of the first embodiment, and the further steps of comparing each detected human face against a list of approved user faces. The method may include the further step of recognizing if each compared human face belongs to a non-approved user and, if so, the method may include the further step of activating the privacy filter on the display.

A fourth embodiment of the present invention may include the features of the third embodiment, and the further step of deactivating the privacy filter on the display, if no non-approved human face is detected on the captured image.

A fifth embodiment of the present invention may include the features of the third embodiment, and the further step of deactivating the privacy filter on the display, if only approved human faces are detected on the captured image.

A sixth embodiment of the present invention may include the features of the first embodiment, and the further step of determining if the display privacy filter on the display is active or inactive. The method may include the further step of setting the image capturing interval to a first interval value if the display privacy filter is inactive and a second, different interval value if the display privacy filter is active.

A seventh embodiment of the present invention may include the features of the first embodiment, wherein the step of activating the privacy filter on the display is performed if the privacy filter is not already active.

An eighth embodiment of the present invention may be directed to an arrangement in an electronic device for controlling a display privacy filter. The display privacy filter may be provided on a display, which may be provided within the electronic device. The electronic device may include an image capturing unit that may be configured to capture an image of an object situated in view of the display. The arrangement may include a detection unit. The detection unit may be configured to detect the number of human faces on a captured image. The arrangement may include an activation unit that may be configured to activate the privacy filter on the display, if more than one face is detected on the captured image.

A ninth embodiment of the present invention may include the features of the eighth embodiment, wherein the electronic device is a portable electronic device represented by a mobile cellular radiotelephone.

A tenth embodiment of the present invention may be directed to a computer program product including computer-readable program code embodied on a computer-readable storage medium. The computer readable program code may be configured to perform the method steps according to any of the embodiments, for example, by executing a set of corresponding instructions.

Thanks to the present solution, images of the objects momentarily situated in front of the display are taken and analysed. If more than one human face, or any unknown human face is detected, an electronically controlled display privacy filter is activated. Thus the risk of forgetting to turn the privacy filter is reduced, not to say eliminated, which improves the security and provide an improved privacy mechanism.

Embodiments of the present method, arrangement, and computer program may advantageously provide a privacy filter that may be turned on/off as it is needed, without any interaction by the user.

### BRIEF DESCRIPTION OF THE DRAWINGS

The present invention will now be described more in detail in relation to the enclosed drawings, in which:

FIG. 1 is a schematic block diagram illustrating embodiments of an electronic device;

FIG. 2A is a schematic block diagram illustrating embodiments of an electronic device;

FIG. 2B is a schematic block diagram illustrating embodiments of an electronic device;

FIG. 3A is a schematic block diagram illustrating exemplary components of an electronic device according to some embodiments;

FIG. 3B is a schematic block diagram illustrating an electronic device according to some embodiments, where the electronic device is embodied as a cellular telephone;

FIG. 4 is a flow chart illustrating embodiments of method steps in an electronic device; and

FIG. 5 is a block diagram illustrating embodiments of an arrangement in an electronic device.

### DETAILED DESCRIPTION

The invention is directed to a method, an arrangement, and a computer program executed in an electronic device, which may be implemented in a number of embodiments described below. This invention may, however, be embodied in many different forms and should not be considered as limited to the embodiments set forth herein; rather, these embodiments are provided so that this disclosure will be thorough and complete, and will fully convey the scope of the invention to those skilled in the art.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

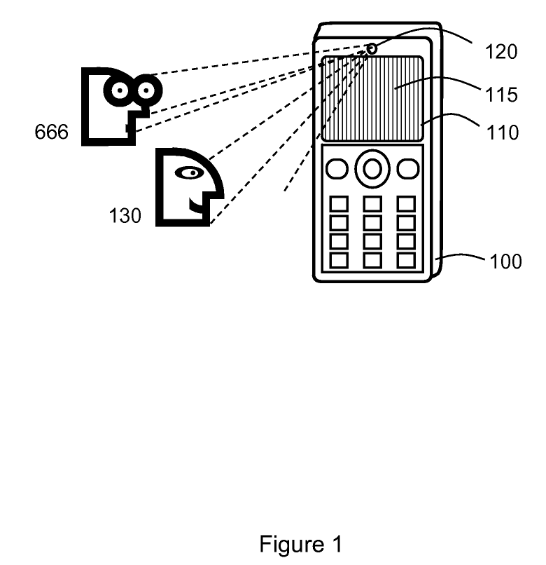

FIG. 1 is a schematic illustration of an embodiment of an electronic device 100 that may include a display 110 and a display privacy filter 115. Electronic device 100 may include an image capturing unit 120. A user 130 may view display 110. When an unauthorized viewer 666 is in a position to espy display 110, display privacy filter 115 may be activated, to thereby at least partially conceal the contents of images on display 110 from a perspective of unauthorized viewer 666, for example, on a flank of user 130.

Electronic device 100, as described herein, may, according to some embodiments, include a personal computer (PC), a TV, a movie playback device, a film screen, a camera, an image displaying device, or any other electronic device having a display. Electronic device 100 may include, for example, a portable electronic device having a display, such as a mobile station, a mobile cellular radiotelephone, a digital enhanced cordless telecommunications (DECT) telephone, a personal digital assistant (PDA), a laptop, a computer, a digital still camera, a digital video camera, or any other kind of electronic device having a display, such as a notebook computer, a walkie-talkie, a hunting radio, a baby monitor, a handheld gaming apparatus, a GPS receiver etc.

Display 110 may sometimes also be referred to as a monitor or a screen. Display 110 may include a piece of electrical equipment which is configured to display the visual representation, e.g., transient images, generated from the video output of electronic device 100. Display 110 may include, for example, liquid crystal display (LCD), a thin film transistor (TFT) LCD, a cathode ray tube (CRT), a raster scan computer monitor, a vector display, a plasma display panel (PDP), a surface-conduction electron-emitter display (SED), an organic light-emitting diode (OLED) display, a monochrome super video graphics array (SVGA), etc., just to mention some arbitrary and non-limiting examples.

Display privacy filter 115 may be electronically controlled, for example, activated and deactivated electronically. When display privacy filter 115 is active, it may operate to decrease the viewing angle of display 110, preventing it from being viewed, for example, from acute angles, such as from one or both sides. User 130 of electronic device 100 may view the display, but the view of unauthorized viewer 666, trying to sneak a glimpse of display 110 from the side, may be partially, substantially, or totally obscured or otherwise distorted. For example, viewing perspectives that deviate from a geometric normal of display 110 may be made progressively worse. However, display privacy filter 115 may also filter out the glare generated from the glass surface of a CRT display as well as the radiation emitted from CRT and LCD displays.

Image capturing unit 120 may reside within electronic device 100 and be configured to capture an image of subjects in front of display 110, for example, in an area in which at least a portion of the graphic information rendered via display 110 may be at least partially visible. Image capturing unit 120 may be, for example, the front camera of a mobile telephone, which otherwise normally is used for video telephony and the like. Mentioned as some nonlimiting examples only, image capturing unit 120 may include a charge-coupled device (CCD) digital camera, an active-pixel sensor (APS), a complementary metal-oxide-semiconductor (CMOS) sensor, Three-CCD or 3CCD, or similar technologies.

Image capturing unit 120 may, according to some embodiments, have a variable frame rate speed. Thus, image capturing unit 120 may capture an image, for example, once every few seconds when display privacy filter 115 is inactive and, for example, once every tenth of a second when display privacy filter 115 is active, according to some embodiments. Other regular or irregular, predetermined or random, time intervals are possible.

The images captured by image capturing unit 120 may be sent to a detection unit, which may be configured to apply a face detection algorithm in order to determine the number of human faces (e.g., those of user 130 and unauthorized viewer 666) present in the captured image. When more than one human face is detected, an electronic signal may sent to electronically controlled display privacy filter 115 in order to activate privacy filter 115, according to some embodiments. The detection unit may reside, for example, within image capturing unit 120 or within electronic device 100. However, the detection unit may, according to some embodiments, even be external to electronic device 100. In such embodiments, electronic device 100 and the detection unit may be connected (e.g., wired or wirelessly), and the digital images distributed to the detection unit via the connection.

Face detection is a computer technology that determines the locations and sizes of human faces in digital images. It detects facial features and disregard other objects, such as animals, buildings, trees, and bodies. The face detection algorithm may be configured to detect frontal human faces and/or multi-view face detection. That is, the detection of faces that are either rotated along the axis from the face to the observer (e.g., profile), or rotated along the vertical or left-right axis, or both.

Some examples of known face detection algorithms that may be used according to the present solution may include, for example, Viola & Jones, Schneiderman & Kanade, or Rowley, Baluja & Kanade: Neural Network-based Face Detection, just to briefly mention some few examples of such algorithms. Other face recognition techniques, crude or sophisticated, may be used.

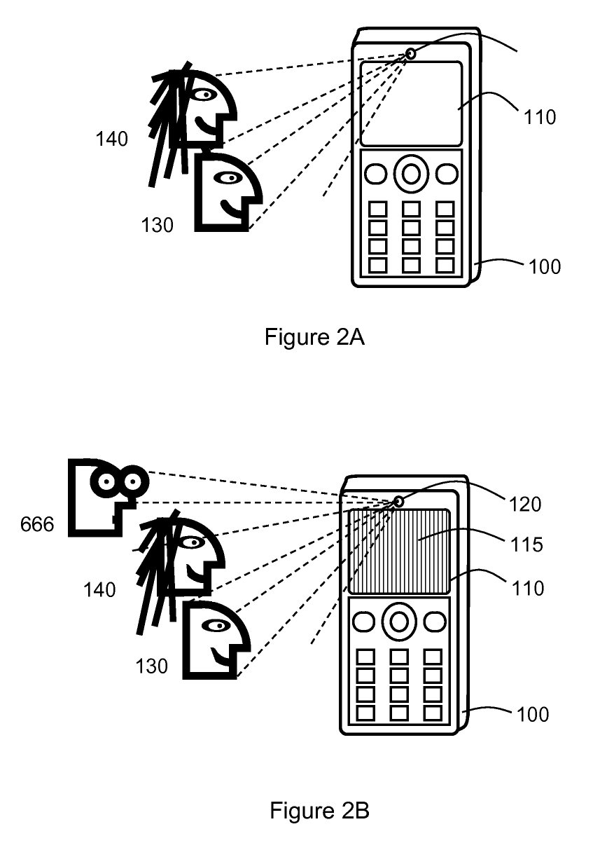

FIGS. 2A and 2B illustrate an embodiment of electronic device 100 including display 110 having display privacy filter 115. User 130 of electronic device 100 may desire and/or be indifferent to share his/her visual experience of display 110 with, for example, a second, appoved viewer 140, but still not want to expose the display to unauthorized viewer 666. According to some alternative embodiments of the present invention, the detection unit may include a face recognition arrangement, for example, a face recognition component. The face recognition algorithm may recognize, identify, and/or verify a particular face represented in a digital image and/or a video frame from a video source. According to some embodiments, face recognition may be performed by comparing select facial features from the image and a database of facial images.

Some facial recognition algorithms identify faces by extracting features from an image of the subject's face. For example, an algorithm may analyze the relative position, size, and/or shape of the eyes, nose, cheekbones, and jaw, etc. These features may then be used to search for stored images that are determined to have having matching features, for example, to a specified degree of likeness. Other algorithms may normalize a gallery of face images and then compress the face data, only saving the data in the image that is useful for face detection. A probe image may then be compared with the face data.

Some non-limiting examples of face recognition algorithms that may be used according to some embodiments comprise Eigenface, Fisherface, the Hidden Markov model, and the neuronal motivated dynamic link matching. Other crude or sophisticated face recognition techniques may be used.

A further check thus may be performed involving the activation of a face recognition algorithm, in order to verify if the detected human face(s) within the captured image is approved by user 130 in control of electronic device 100. This may be performed by comparing the detected human faces against a database including the approved viewers specified by user 130. According to some embodiments, a comparison against a list of images included in the user 130's contact list may be performed. According to some embodiments, user 130 may establish a database including images of faces of those individuals on the approved viewer list.

According to the scenario depicted in FIG. 2A, appoved viewer 140 may be included in user 130's database of authorized viewers. Thus a plurality of viewers may be present in front of the display 110 (e.g., as detected in the captured image), without triggering display privacy filter 115.

In the scenario depicted in FIG. 2B, unauthorized viewer 666, who is not included in user 130's database of approved viewers, may again try to stealthily get a glimpse of display 110. As the face of unauthorized viewer 666 is not recognized by the face recognition algorithm, a signal is sent to privacy filter 115 to cause privacy filter 115 to activate and thereby at least partially conceal the contents of display 110 from unauthorized viewer 666.

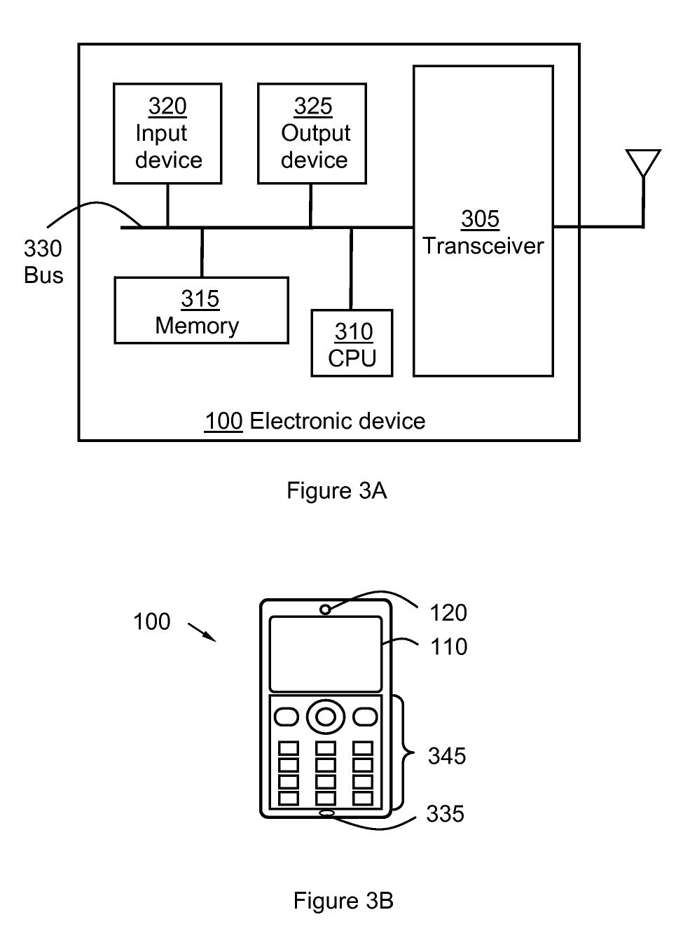

FIG. 3A illustrates electronic device 100 consistent with an exemplary embodiment. Electronic device 100 may include a transceiver 305, a processing unit 310, a memory 315, an input device 320, an output device 325, and/or a bus 330. However it is to be noted that electronic device 100 by no means is limited to communication devices or portable communication devices.

Optional transceiver 305 may include transceiver circuitry for transmitting and/or receiving symbol sequences using radio frequency signals via one or more antennas. Transceiver 305 may include, for example, a RAKE or a GRAKE receiver.

Processing unit 310 may include a central processing unit (CPU), processor, microprocessor, or processing logic that may interpret and execute instructions. Processing unit 310 may perform all data processing functions for inputting, outputting, and/or processing of data including data buffering and device control functions, such as call processing control, user interface control, or the like.

Memory 315 may provide permanent, semi-permanent, and/or temporary working storage of data and instructions for use by processing unit 310 in performing device processing functions. Memory 315 may include ROM, RAM, large-capacity storage devices, such as a magnetic and/or optical recording medium and its corresponding drive, and/or other types of memory devices. Input device 320 may include mechanisms for entry of data into electronic device 100. The keypad may permit manual user entry of data into electronic device 100. The microphone may include mechanisms for converting auditory input into electrical signals. Display 110 may provide a user interface, e.g., a graphical user interface, that can be used by user 130 for selecting device functions. Display 110 may include any type of visual display, such as, for example, an LCD, a plasma screen display, an LED display, a CRT display, an OLED display, etc.

The output device 325 may comprise mechanisms for outputting data in audio, video and/or hard copy format. For example, the output device 325 may comprise a speaker that comprises mechanisms for converting electrical signals into auditory output. Output device 325 may include display 110 that may display output data to user 130. For example, display 110 may provide a GUI that displays output data to user 130. Bus 330 may electrically interconnect the various components of electronic device 100 to permit the components to communicate with one another.

The configuration of components of electronic device 100 illustrated in FIG. 3A is for illustrative purposes only. Other configurations including more, fewer, and/or a different arrangement of components may be implemented. For example, in some implementations, electronic device 100 may not include transceiver 305.

FIG. 3B illustrates an exemplary implementation of electronic device 100 in which electronic device 100 is a cellular radiotelephone. As shown in FIG. 3B, electronic device 100 may include, for example, a microphone 335, e.g., of input device 320 for entering audio information into electronic device 100, a speaker 340, e.g., of output device 325 for providing an audio output from the radiotelephone, a keypad 345, e.g., of input device 320 for manual entry of data or selection of telephone functions, and display 110 that may visually display data and/or images and/or which may provide a user interface that may be used to enter data or to select telephone functions, in conjunction with keypad 345.

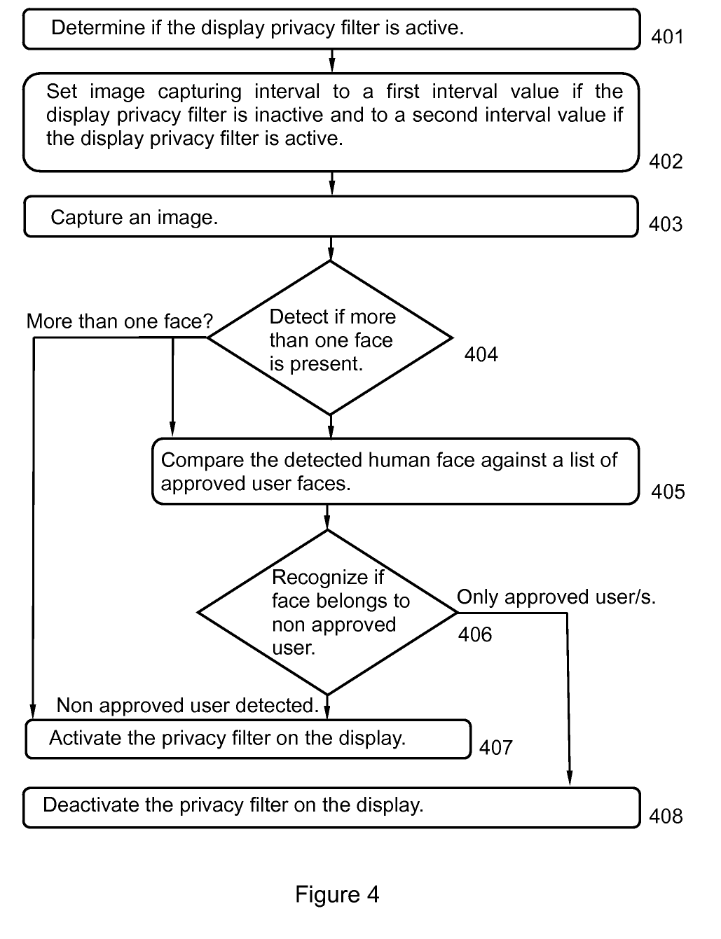

FIG. 4 is a flow chart illustrating a method that may be implemented in electronic device 100 for controlling display privacy filter 115. Display privacy filter 115 may be provided for display 110 of electronic device 100. Electronic device 100 may include image capturing unit 120. Image capturing unit 120 may be configured to capture an image of an object within a predetermined line of sight of display 110. Display 110 may be adapted to display visual data, such as film sequences, movies, images, graphics, maps, web pages, text, games, video telephony connections, etc.

To appropriately control display privacy filter 115, the method may include a number of Steps 401-408. It is however to be noted that some of the described method steps are optional and only to be performed in some embodiments. Further, it is to be noted that the method Steps 401-408 may be performed in any arbitrary chronological order and that some of them, e.g., Step 401 and Step 403, or even all steps may be performed simultaneously and/or in an altered, arbitrarily rearranged, decomposed or even completely reversed chronological order. The method may comprise the following exemplary steps:

### Step 401

Step 401 may be performed in some embodiments, in which a determination may be made whether display privacy filter 115 on display 110 is active/inactive. The mode of display privacy filter 115 may determine the achievements of the present method. Thus, when display privacy filter 115 is inactive, the present method may determine whether the preset conditions for activating display privacy filter 115 exist, and vice versa.

### Step 402

Step 402 may be performed in some embodiments, in which the image capturing interval may be set to a first interval value when display privacy filter 115 is inactive, and a second interval value when display privacy filter 115 is active. The first interval value may be different from the second interval value, according to some embodiments. For example, when display privacy filter 115 is inactive, a more frequent interval of capturing images may be used than when the display privacy filter 115 is active. According to some embodiments, the first interval value may be set, for example, to capturing one image every few seconds or so, such as one image about every 1-3 seconds or so. Other intervals are possible.

When display privacy filter 115 is active, the image capturing interval may be reduced, for example, in order to save energy. Also, it may be disturbing for user 130 when display privacy filter 115 is frequently activated/deactivated in response to detection of transient passers-by that do not pose a credible threat of ogling. Such circumstances may warrant deactivation of display privacy filter 115. According to some embodiments, the second interval value may be set to, for example, one image every tenth of a second, such as one image about every 10-15 seconds. Other intervals are According to some embodiments, the second interval value may be set based on, for example, the corresponding sensitivity of the content being displayed and/or the environment in which electronic device 100 is being used.

According to some embodiments, electronic device 100 may be configured to not activate display privacy filter 115 when more than one person's face is detected and/or when an authorized person's face is recognized in fewer than a predetermined number of captured images, for example, corresponding to a predetermined amount of time. In this manner, needless activation of display privacy filter 115 may be avoided for transient passers-by that would not have sufficient time to glean any of the displayed information.

According to still other embodiments, user 130 may be alerted to the fact that conditions warrant activation of display privacy filter 115 and be given the opportunity to select to not activate display privacy filter 115 during a predetermined deferral period (e.g., 5, 10, 15 secs., etc.), after which, display privacy filter 115 will be activated, absent intervention by user 130.

### Step 403

In Step 403, an image may be captured by image capturing unit 120. According to some embodiments, image capturing unit 120 may be configured to continuously capture images of the objects situated in front of display 110, as long as display 110 and/or some particular functionality, such as video display related to, for example, pornographic material or a gaming application, is turned on.

Electronic device 100 may activate the image capturing function in image capturing unit 120, for example, camera functionality, upon powering up of electronic device 100, according to some embodiments. The activation of image capturing function may also be accomplished manually by user 130.

### Step 404

In Step 404, the number of human faces present on the captured image may be detected. The detection may be made by computation, using a face detection algorithm.

### Step 405

Step 405 may be performed in some embodiments, in which the detected human faces in the image may be compared against representations associated with faces corresponding to a list and/or a particular sub-list of approved viewers. The list may be stored in a database associated with electronic device 100.

According to some embodiments, the detected human faces in the image may be compared against a list and/or a particular sub-list of non-approved users. Such circumstances may obtain, for example, in an office setting in which an employee prefers that information not be viewed by a superior (e.g., user 130's supervisor), but does not mind sharing the display content with other employees such as user 130's colleagues.

In some embodiments, user 130 may designate unauthorized and/or approved viewer groups corresponding to particular viewers. In still other embodiments, user 130 may designate unauthorized and/or approved viewer groups corresponding to categories of viewers based on, for example, select shared characteristics, such as ages, genders, etc. For example, a facial characteristic detection algorithm may determine whether a viewer is a male/female, a minor/adult, etc. Thus, user 130 may configure display privacy filter 115 to be activated when a visage of that of a female or a minor is detected in the captured image, when user 130 is viewing, for example, pornographic material via display 110. In another example, electronic device 100 may be configured to determine whether the image content being displayed via display 110 is suitable for minors (e.g., pornographic), and automatically activate display privacy filter 115 when a visage of that of a minor is detected in the captured image.

### Step 406

Step 406 may only be performed in some embodiments, in which a determination is made as to whether any of the detected human faces belongs to an unauthorized viewer 666.

### Step 407

In Step 407, when more than one face is detected on the captured image, privacy filter 115 may be activated with respect to display 110. According to some embodiments, privacy filter 115 may be activated when it has been determined that any of the detected human faces likely belongs to unauthorized viewer 666. The activation may be performed by sending an electronic signal to electronically controlled display privacy filter 115.

According to some embodiments, privacy filter 115 associated with display 110 may be activated only when privacy filter 115 is not currently active.

### Step 408

In Step 408, privacy filter 115 for display 110 may be deactivated, when only one face is detected on the captured image.

According to some embodiments, privacy filter 115 may only be activated on display 110 when no unauthorized human face is detected in the captured image.

According to some embodiments, privacy filter 115 of display 110 may be deactivated when only approved faces are detected on the captured image.

According to some embodiments, privacy filter 115 for display 110 may be deactivated only when privacy filter 115 is active.

According to still other embodiments, privacy filter 115 may be applied to select areas of display 110 based on a detected position of unauthorized viewer 666. For example, unauthorized viewer may be determined to be to one side of display 110. In this circumstance, privacy filter 115 may be unilaterally applied to display 110 such that contents of images being rendered via display may not be readily viewed from unauthorized viewer 666's vantage point, but may, however, still be discernible from an opposite side of user 130, for example, from a vantage point of approved viewer 140.

According to still other embodiments, upon detecting unauthorized viewer 666 in the captured image, electronic device 100 may include logic to generate a graphic and/or audible signal that indicates that unauthorized viewer 666 is able to view display 100 and may alert user 130 and/or unauthorized viewer 666 to that fact. In the latter case, electronic device 100 may be configured to generate an audible and/or visual request for privacy that may be presented to unauthorized viewer 666. Electronic device 100 may be configured to progress through a number of such messages when a determination is made that unauthorized viewer 666's viewing persists in spite of the presented request(s).

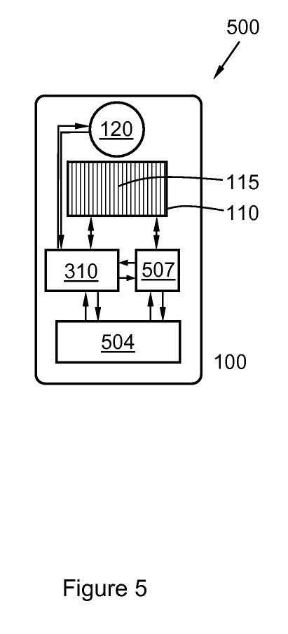

FIG. 5 is a block diagram illustrating embodiments of an arrangement 500 that may be provided in electronic device 100. Electronic device 100 may be a portable electronic device represented by, for example, a mobile cellular radiotelephone, according to some embodiments.

Arrangement 500 may be configured to perform Steps 401-408 for controlling display privacy filter 115 with respect to display 110. Display 110 may be associated with electronic device 100. Electronic device 100 may include image capturing unit 120. Image capturing unit 120 may be configured to capture an image of an object situated in front of display 110.

For the sake of clarity, any internal electronics of arrangement 500, not completely necessary for explaining the present method has been omitted from FIG. 5.

Arrangement 500 may include a detection unit 504. Detection unit 504 may be configured to detect a number of human faces on a captured image is greater than one. Arrangement 500 may include an activation unit 507. Activation unit 507 may be configured to activate privacy filter 115 via display 110, for example, when a determination is made that more than one face is detected on the captured image.

Arrangement 500 may include a determination unit 501 that may be configured to determine if display privacy filter 115 on the display 110 is active/inactive.

Arrangement 500 may include a setting unit 502 that may be configured to set the image capturing interval to a first interval value when display privacy filter 115 is inactive and a second interval value when display privacy filter 115 is active.

Arrangement 500 may include a comparison unit 505 that may be configured to compare the detected human faces in a captured image to those included in a list of approved user faces.

Arrangement 500 may include a recognition unit 506 that may be configured to recognize and determine if any of the detected human faces substantially resembles that of a non-approved viewer.

In addition, Arrangement 500 further may include a deactivating unit 508 that may be configured to deactivate privacy filter 115 on display 110, when only one face is detected based on results of an analysis of the captured image. Deactivating unit 508 may alternatively be configured to deactivate privacy filter 115 on the display 110, when only approved human faces are detected from an analysis of the captured image. According to some embodiments, deactivating unit 508 may be configured to deactivate privacy filter 115 on the display 110, only when no non-approved human face are detected based on an analysis of the captured image.

Arrangement 500 may, according to some embodiments, include processing unit 310. Processing unit 310 may include a CPU, a processor, a microprocessor, and/or processing logic that may interpret and execute instructions. Processing unit 310 may perform all or some data processing functions for inputting, outputting, and/or processing of data including data buffering and device control functions, such as call processing control, user interface control, or the like.

It is to be noted that described units 110-508 included within arrangement 500 may be regarded as separate logical entities but not with necessity as separate physical entities. Any, some, or all of units 110-508 may be integrated or co-arranged within the same physical unit. However, in order to facilitate the understanding of the functionality of arrangement 500, units 110-508 are illustrated as separate physical units in FIG. 5.

The method in electronic device 100 for controlling display privacy filter 115, according to the present method, may be implemented through one or more processors 310 in electronic device 100, together with computer program code for performing the functions of the described method. The program code mentioned above may also be provided as a computer program product, for instance in the form of a data carrier carrying computer program code for performing the method according to the present invention when being loaded into processing unit 310. The data carrier may be a CD ROM disc, a memory stick, or any other appropriate medium such as a disk or tape that can hold machine-readable data. The computer program code can furthermore be provided as pure program code on a server and downloaded to electronic device 100 remotely.

Thus a computer program including instruction sets for performing the method according to at least some of method steps 401-408 may be used for implementing any of the previously described methods or portions thereof.

Further, a computer program product comprising computer-readable program code embodied on a computer-readable medium, the computer readable program code being configured to perform the method steps defined in the independent method claim.

As will be appreciated by one of skill in the art, the present invention may be embodied as arrangement 500 within electronic device 100, a method or a computer program product. Accordingly, the present invention may take the form of an entirely hardware embodiment, a software embodiment, or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in any arbitrary object oriented programming language such as Java®, Smalltalk or C++. However, the computer program code for carrying out the steps of the present method may also be written in any conventional procedural programming languages, such as the “C” programming language and/or a lower level assembler language. The program code may execute entirely on arrangement 500, partly on arrangement 500, as a stand-alone software package, partly on arrangement 500 and partly on a remote computing device or entirely on the remote computing device. In the latter scenario, the remote computing device may be connected to arrangement 500 through a local area network (LAN) and/or a wide area network (WAN), or the connection may be made to an external computer, for example, through the Internet, using an Internet service provider (ISP).

Furthermore, the present method is described in part above with reference to flowchart illustrations of the method in FIG. 4 and/or block diagrams of arrangement 500 in FIG. 5 according to embodiments of the invention. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks, which may be performed in any successive order and/or parallel.

These computer program instructions may also be stored in a computer-readable memory storage device that can direct a computer or other programmable data processing apparatus to function in a particular manner, such that the instructions stored in the computer-readable memory produce an article of manufacture including instruction means which implement the function/act specified in the flowchart and/or block diagram block or blocks in FIGS. 4 and/or 5.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The terminology used in the detailed description of the particular exemplary embodiments illustrated in the accompanying drawings is not intended to be limiting of the invention.

Like reference numbers signify like elements throughout the description of the figures.

As used herein, the singular forms “a,” “an,” and “the” are intended to include the plural forms as well, unless expressly stated otherwise. It should be further understood that the terms “comprises,” “comprising,” “includes,” and/or “including” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present.

Furthermore, “connected” or “coupled” as used herein may include wirelessly connected or coupled. As used herein, the term “and/or” includes any and all combinations of one or more of the associated listed items.

Unless otherwise defined, all terms including technical and scientific terms used herein have the same meaning as commonly understood by one of ordinary skill in the art to which electronic device 100 and the present method belongs. It will further be understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. In an electronic device including an image capturing unit and a display, a method of controlling a filter on the display, comprising:
capturing an image;
determining whether more than one human face is present in the captured image; and
activating or deactivating the filter on the display based on a result of the determination.

2. The method of claim 1, where when more than one human face appears in the captured image, the method further comprising:
comparing each of the human faces against a plurality of stored faces corresponding to unauthorized viewers, and
determining, based on a result of the comparing, whether at least one of the human faces corresponds to an unauthorized viewer, and
where when the at least one human face corresponds to the unauthorized viewer, activating the filter on the display.

2. The method of claim 1, where when not more than one human face appears in the captured image, the method further comprising:
deactivating the filter on the display.

3. The method of claim 1, where when more than one human face appears in the captured image, the method further comprising:
activating the filter on the display.

4. The method of claim 1, where when none of the human faces corresponds to the unauthorized viewer, the method further comprising:
deactivating the filter on the display.

5. The method of claim 1, where when only approved human faces appear in the captured image, the method further comprising:
deactivating the filter on the display.

6. The method of claim 1, further comprising:
determining whether the filter on the display is active or inactive; and
setting an image capturing interval to a first interval value when the filter is inactive and a second, different interval value when the filter is active.

7. The method of claim 1, where the activating the privacy filter on the display is performed when the privacy filter is not already active.

8. A device comprising:
a display;
image capturing unit to capture an image of an object in a viewing are of the display;
a detection unit to determine a number of human faces appearing in the image; and
an activation unit to activate a privacy filter on the display based on a result of the determination.

9. The device of claim 8, where the electronic device is a mobile cellular radiotelephone.

10. A computer program product comprising computer-readable program code embodied on a computer-readable storage medium, the computer readable program code being configured to execute asset of instructions comprising:
instructions to capture an image;
determine whether more than one human face is present in the captured image; and
activate or deactivate the filter on the display based on a result of the determination.
